(19) United States
(12) Patent Application Publication
(10) Pub. No.: US 2005/0223641 A1
(43) Pub. Date: Oct. 13, 2005

(54) Flower pot and method of packaging the same

(76) Inventor: Martinus Fredericus Johannes Duivenvoorden, De Zilk (NL)

Correspondence Address: AKERMAN SENTERFITT, P.O. BOX 3188, WEST PALM BEACH, FL, 33402-3188, US

(21) Appl. No.: 10/515,414

(22) PCT Filed: May 22, 2003
(86) PCT No.: PCT/NL03/00383

§ 371 Date: May 2, 2005

(30) Foreign Application Priority Data
May 22, 2002 (NL) 1020652

(51) Int. Cl. A01G 9/02

(52) U.S. Cl. 47/72

(57) ABSTRACT

The invention relates to a flower pot, having a bottom and a wall portion extending from the bottom upward, wherein the wall portion comprises at least one incision, into which a foil material can be inserted so as to cover the pot all round and at the bottom. According to a preferred embodiment the at least one incision is provided in the upper half of the wall portion. According to a further embodiment the at least one incision is provided through the wall portion. This makes a simple manner possible for attaching a foil material to a flower pot.

The present invention relates to a container, having a bottom and a wall portion extending from the bottom upward. The invention also relates to a method of packaging a plant in a flower pot.

Although the invention relates to containers in general; hereafter reference will be made chiefly to flower pots. However, the invention is not limited to just flower pots. Everywhere in the description the term “flower pot” may also be read as “container”.

Flower pots of the kind mentioned in the preamble are generally known in practice. As a rule, such flower pots are directly filled with a pot plant or a flower. In order to as much as possible avoid moisture leaking from the flower pot, the wall portion of the flower pot is embodied without openings. However, the bottom is usually provided with openings to allow excess water to drain from the flower pot. However, when selling pot plants and flowers, there is the disadvantage of the possibility of moisture leaking from the flower pot, which may give rise to soiling and unhygienic conditions. In order to avoid this, the flower pot is often wrapped in a moisture-proof foil so as to obtain a leak-proof packaging. In practice, the flower pot is placed on a sheet of foil material and the foil material is folded upward and around the pot and the flower or plant, and secured. Securing may be realised by means of adhesive strips, which may be provided both on the pot and on the foil, or by means of a, optionally elastic, band. The position for tying needs to be above the rim of i) the flower pot in order to avoid this fastening mechanism sliding down and off the flower pot. This problem arises especially with flower pots that are wider at the top. According to another known method, the foil, before being applied around the flower pot, is formed by at least partly fusing the foil material or a hot-melt coating provided thereon, so as to obtain a form into which a flower pot can be placed.

It is further known to provide other types of finishes than the above-mentioned moisture-proof foil materials around flower pots, e.g. sheets of gauze, textile, paper, etc. and combinations thereof or possibly combinations together with the foil materials. Such finishes are generally intended for decoration. Securing the same around the flower pot, however, chiefly occurs in-the same manner as mentioned above with respect to the moisture-proof foil.

When hereafter reference is made to “foil material”, this applies as much to the above-mentioned materials as to sheets of gauze, textile, paper, etc. and combinations thereof, or possibly in combination with the foil materials.

In the art, a number of the above-mentioned solutions are proposed in, for example, the American patent specifications U.S. Pat. No. 5,459,976, U.S. Pat. No. 4,733,521, U.S. Pat. No. 5,105,599, U.S. Pat. No. 5,410,856, U.S. Pat. No. 5,526,932, U.S. Pat. No. 5,685,126 and U.S. Pat. No. 5,450,707.

A general disadvantage of all these earlier mentioned solutions is the fact that the packaging is difficult to realise because of extensive operations that have to be performed. In the case of adhesive strips, the disadvantage consists of the difficulty of separating the foil material from the flower pot. Also, left over laminated materials that cannot readily be reused create a burden on the environment.

It is the object of the invention to provide an improved flower pot. A more particular object of the invention is to provide a flower pot that can easily be combined with a foil material so as to prevent leaking of moisture and soil.

It is also the object of the invention to provide an improved flower pot and a simple manner for attaching a foil material to the flower pot and for removing it again.

In order to obtain at least one of the abovementioned objectives, the invention provides a container as mentioned in the preamble, and which is characterised in that the wall portion comprises at least one incision, into which a foil material can be inserted so as to cover the container all round. The container according to the invention makes it possible in a very simple manner to attach a foil material to the container so that it is fixed but removable. The foil material that is positioned so as to abut to the incision, can be fixed by insertion into the incision on the flower pot. By providing the incision with a suitable shape and size, easy removal of the foil material from the incision will be prevented. Some force will be required. The foil material may, for example, be folded around the flower pot and then pressed into the incisions. When the flower pot is placed on a sheet of foil material and this foil material is folded upward against the flower pot, it will usually be necessary to press several layers of foil material that are folded over each other into an incision. Therefore, the size of the incision is such that preferably several layers of foil material can be pressed into it.

In accordance with the preferred embodiment, the at least one incision is provided in the upper half of the wall portion. In this way the foil material is positioned around the flower pot in a particular manner. In that case also, the foil material extending further upward, will remain in the particular position up to a considerable height above the top rim of the flower pot.

In accordance with a further embodiment, the at least one incision is provided through the entire thickness of the wallportion. In that case the foil material may also be inserted through the entire wall thickness of the flower pot, allowing a secure attachment.

In accordance with another preferred embodiment of the invention, the at least one incision is provided superficially in the surface of the wall portion only. If the structure of the flower pot is sufficiently resilient, the foil material will likewise stay properly positioned. If the wall at the position of the incision is sufficiently thick, the incision may be an incision going right through over the entire circumference.

In still another embodiment, the incision is only superficial but such, that at a chosen point of pressure it can readily be pressed through to allow a foil to be pushed through the wall of a flower pot. The superficially provided incision may then be applied around the entire circumference or distributed over the circumference.

With the flower pot according to the invention it is possible to apply numerous shapes of incisions. A number of preferred embodiments for the incision are a substantially straight line, a curved line, a T shape, a Y shape, an X shape, a [symbol] , an L, a V, a W, a +, a *, etc.

The incision in the flower pot according to the invention may be made in several ways. One preferred incision is made without removing any material from the flower pot. For example, such an incision may be made by means of cutting. If a relatively thick foil material, or several layers of foil material have to be inserted into the incision, the incision is preferably made by die cutting or punching, possibly by drilling. According to a further preferred embodiment, combinations of cutting and die cutting, punching or drilling are possible. Of course, it is also possible to provide the incision simultaneously with the fabrication of the flower pot by affording provisions for the purpose in a mould for injection moulding, or other method of forming the flower pot.

The size of the incision depends substantially on the amount of foil material to be inserted into the incision. However, for a flower pot having a diameter ranging from 10 to 25 cm it is generally preferred for the incision to have a length of 2.5 cm, preferably 2.0 cm, more preferably 1.5 cm and still more preferably 1.0 cm. An incision of such a size facilitates secure fastening. The size and number of incisions depends not only on the size of the flower pot, but also on the thickness of the wall portion of the flower pot at the place of incisions, the type of material from which the flower pot is fabricated, the type and the thickness of the material from which the foil is fabricated, the distance of the incision to the top rim of the flower pot and/or to the bottom of the flower pot and the mutual distance of the incisions in relation to one another. Within the scope of the invention, a person skilled in the art is capable to determine a suitable size and shape of incision to obtain an adequate clamping action for the foil.

It is further preferred for at least two incisions to be provided at a regular mutual distance, that is to say on wall portions of the flower pot opposite each other.

If at least two incisions are provided in the wall portion of the flower pot, it is preferred for both of these to be substantially at the same distance from the bottom or, in accordance with the other preferred embodiment, substantially at the same distance from the top rim of the flower pot. However, it is equally possible to provide the incisions at different heights.

In order to facilitate a simple method of manufacture and to provide the material of the flower pot with sufficient resilience, the flower pot is preferably made from a plastic material. According to a further preferred embodiment, the flower pot is made from a biodegradable material. Especially in the case of garden plants and the like, the plant can then be planted with flower pot and all into the soil. Merely the foil material serving for decoration and/or protection can then simply be removed from the flower pot by removing the inserted portions from the incisions, and the plant together with the flower pot can be planted in the soil.

The method for packaging a plant and a flower pot is characterised in that the same comprises the provision of a plant in a flower pot, positioning a foil material under and around the flower pot, and inserting the foil material into suitably shaped and dimensioned incisions provided in the wall portion of the flower pot so that by means of clamping action the foil material is detachably secured in the at least one incision. This method allows for a very simple and quick, and therefore economical, packaging of plants and flowers in pots, while the packaging can also easily be removed.

Hereafter, the invention will be further elucidated with reference to a number of drawings. These drawings are merely shown to illustrate a preferred embodiment of the invention. The drawings are not intended to limit the protective scope of the invention.

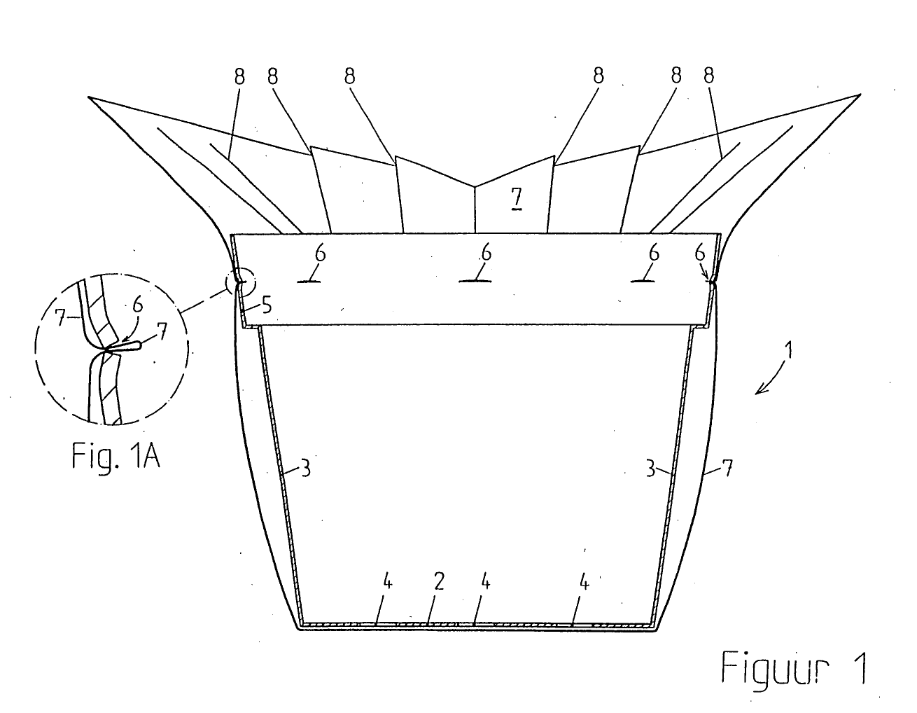

FIGS. 1-1A show a cross section of a flower pot with foil material according to the invention.

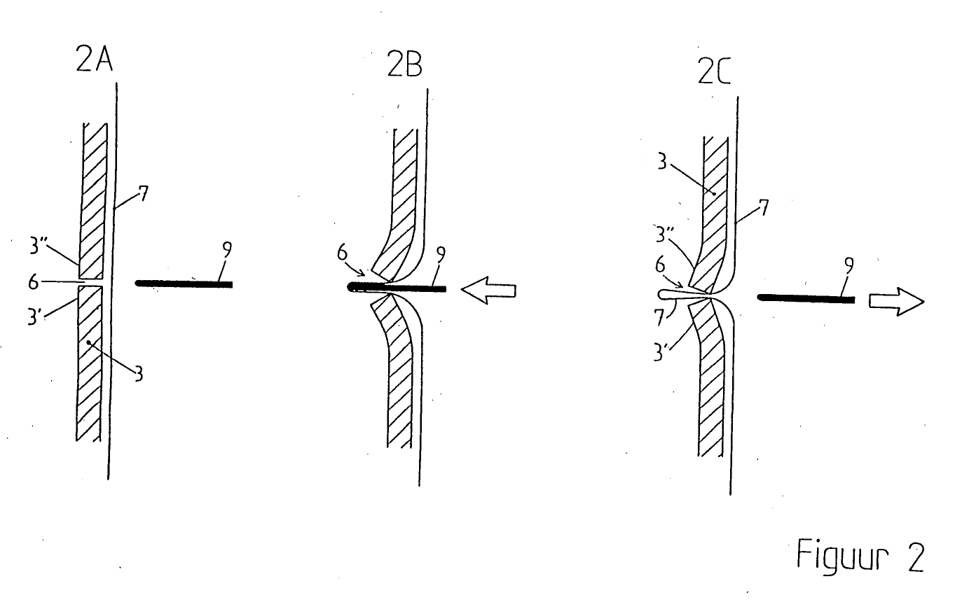

FIGS. 2A-2C show a portion of the wall of a flower pot according to FIG. 1.

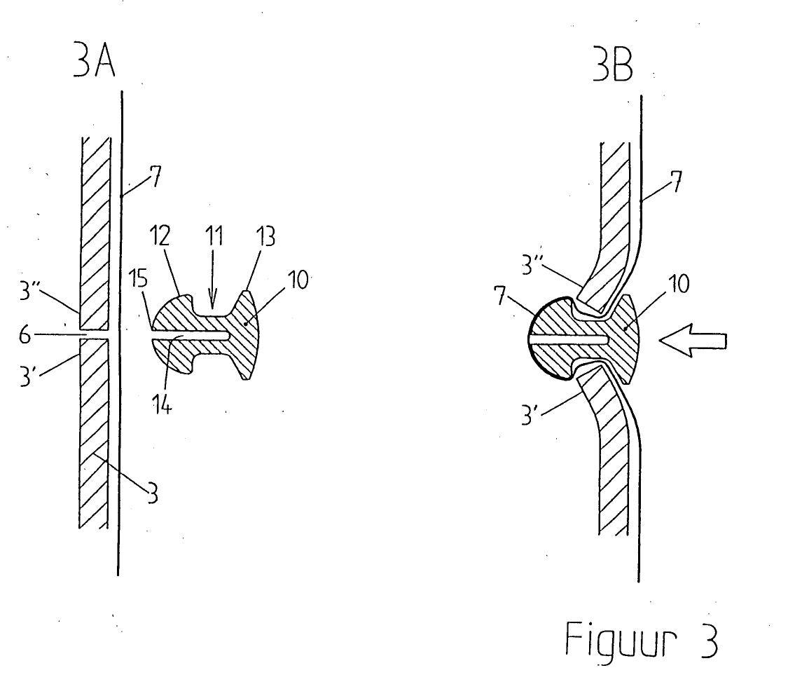

FIGS. 3A-3B show an alternative embodiment of the wall of the flower pot according to FIG. 1.

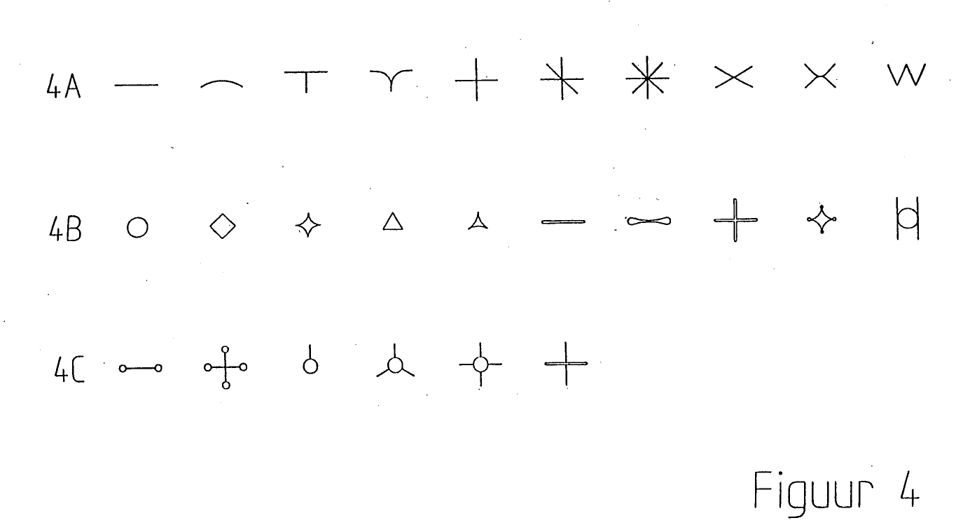

FIGS. 4A-4C show examples of incisions.

FIG. 1 shows a flower pot 1, having a bottom 2 and a wall portion 3 extending from the bottom upward. The bottom 2 is provided with openings 4 for draining excess moisture. The top portion of the wall portion 3 is provided with an outwardly projecting rim 5. This rim 5 is provided over its entire circumference with incisions 6. The cross section of the flower pot 1 according to FIG. 1 is taken through the centre of the flower pot 1 and it is quite apparent that the flower pot has eight incisions 6 evenly distributed over the rim 5. Around the flower pot a foil material 7 is provided. This is placed under the flower pot 1 and extends upward along the wall portion 3 of the flower pot 1. This causes the foil material to become slightly folded. This is shown by the creases 8 of the foil material 7. As can be seen in the detailed view of FIG. 1A, the foil material 7 is pushed through the incisions 6 so that the foil material 6 is at the inside of the flower pot 1. Pushing the foil material 7 through the incisions 6, causes the wall portion 3 of the flower pot 1 to bend slightly. Due to the thickness of the inserted foil material 7, this deformation will be retained in some measure as long as the foil material is in the incision 6. This prevents the foil material 7 from becoming easily removed from the incision 6. When the foil material 7 is inserted into the incision 6, the fold formation will increase the clamping force the deeper the foil material 7 is pushed into the incision 6. The clamping force can thus easily be determined.

The foil material 7 can be inserted into the incisions 6 in a simple manner. FIG. 2 shows in three steps (FIGS. 2A, 2B and 2C) how insertion can be realised. FIG. 2A shows a wall portion 3 of a flower pot 1 (not shown) according to the invention and a foil material 7 disposed substantially parallel to the wall portion 3. A mandrel 9, which mandrel is positioned at the height of the incision 6, pushes against the foil material 7 and into the opening 6, thereby inserting the foil material 7 into the opening 6 (see FIG. 2B). This insertion may be performed automatically or manually.

This will cause a slight deformation to the wall portion 3. It is observed that the incision 6 in FIG. 2A is shown as a section taken out of the wall portion 3. In practice, the incision 6 can be provided by making a cut so that the two wall portions 3′, 3″′ abut against each other. FIG. 2C subsequently shows the last step wherein the mandrel 9 is withdrawn from the opening and wherein the force of the two wall portions 3′, 3″ pressing together, retain the foil material 7 in the opening 6. In this way, the foil material 7 is attached to the wall portion 3 of the flower pot 1 (not shown).

A further simple embodiment of the invention is possible. This is shown, for example, in FIG. 3. If the foil material 7 needs to be securely attached to the wall portion 3, a plug 10 may be used. The plug 10, as shown in FIG. 3A, is positioned in a similar manner as the mandrel 9 shown in FIG. 2. By positioning the plug 10 against the foil material 7 and subsequently pushing it into the opening 6 as shown in FIG. 3B, the plug will stay lodged in the opening 6 and will securely remain there. The middle portion 11 of the plug 10 preferably has a smaller diameter than the sections 12 and 13 at either side of the middle section 11. By pushing the plug to the middle section 11 into the opening 6, the same will stay securely fixed in the opening 6. According to a further preferred embodiment, the plug 10 is provided with at least one recess 14, which may extend parallel to the longitudinal axis of the plug 10, from the front 15 to the middle section 11. This facilitates the plug's 10 insertion into and removal from the opening 6, if the plug is fabricated from a resilient material.

FIG. 4 finally shows a number of preferred embodiments of the incisions 6. FIG. 4A shows a number of embodiments that can be provided by making cuts into the wall 3 of the flower pot 1. FIG. 4B shows a number of embodiments that can be provided by means of die cutting or punching, optionally by drilling.

FIG. 4C finally shows a number of possible suitable embodiments which may be formed by means of combinations of cuts and die cutting.

The invention is not limited to the embodiments described above and shown in the Figures. Within the scope of the appended claims, various modifications are possible. Such adaptations and modifications are obvious to a person skilled in the art.

The flower pot may be fabricated, for example, from biodegradable material. In that case the foil material can be removed from the flower pot without leaving remnants of non-degradable materials resulting from the flower pot.

Flower pots are generally available in many forms and sizes, wherein the bottom is usually flat and the wall portion extending upward may be formed as desired, for example, conical. The bottom is generally circular and the wall portion extends conically upward, with the diameter of the flower pot being larger at the top side than near the bottom. Other shapes are equally possible, for example, a square bottom, with the wall portions optionally tapering upward and outward. Furthermore, the term flower pots denotes both the surrounding pot and the pot containing the plant.

1. A container, having a bottom and a wall portion extending from the bottom upward, characterised in that the wall portion comprises at least one incision, into which a foil material can be inserted so as to cover the container at least partially all round.

2. A container according to claim 1, characterised in that the at least one incision is provided in the upper half of the wall portion.

3. A container according to claim 1, characterised in that the at least one incision is provided through the wall portion.

4. A container according to claim 1, characterised in that the at least one incision is superficial.

5. A container according to claim 1, characterised in that the shape of the at least one incision is chosen from the group consisting of a substantially straight line, a curved line, a T shape, a Y shape, an X shape, a [symbol] shape, an L shape, a V shape, a W shape, a + shape, and a * shape.

6. A container according to claim 1, characterised in that the at least one incision is a shape made into the wall portion by die cutting.

7. A container according to claim 1, characterised in that the at least one incision is a combinations of a cut and a die cut shape.

8. A container according to claim 1, characterised in that the at least one incision has a length of 2.5 cm.

9. A container according to claim 1, characterised in that the circumference of the wall portion is provided with at least two incisions at a regular mutual distance.

10. A container according to claim 1, characterised in that the circumference of the wall portion is provided with at least two incisions substantially at the same distance from the bottom.

11. A container according to claim 1, characterised in that the circumference of the wall portion is provided with at least two incisions substantially at the same distance from the top rim of the flower pot.

12. A container according to claim 1, characterised in that the same is made from a plastic material.

13. A container according to claim 1, characterised in that the same is made from a biodegradable material.

14. A container according to one of the preceding claim 1, characterised in that the same is a flower pot.

15. A method of packaging a plant in a flower pot, comprising the provision of a plant in a flower pot, positioning a foil material around the flower pot, and inserting the foil material into suitably shaped and dimensioned incisions provided in the wall portion of the flower pot so that by means of clamping action the foil material is detachably secured in the at least one incision.

16. A method according to claim 15, characterised in that the foil material is positioned under the flower pot.

17. A method according to claim 16, characterised in that a plug is used to fix the foil material in the incision.

18. A container according to claim 8, characterised in that the at least one incision has a length of 2.0 cm.

19. A container according to claim 8, characterised in that the at least one incision has a length of 1.5 cm.

20. A container according to claim 8, characterised in that the at least one incision has a length of 1.0 cm.
